(19) United States
(12) Patent Application Publication
(10) Pub. No.: US 2011/0217932 A1
(43) Pub. Date: Sep. 8, 2011

(54) INPUT DEVICE WITH MULTI-OBJECT SWITCH LINKAGES

(75) Inventor: Yu-Chun HSIEH, New Taipei City (TW)

(73) Assignee: ZIPPY TECHNOLOGY CORP., New Taipei City (TW)

(21) Appl. No.: 13/072,062

(22) Filed: Mar. 25, 2011

Related U.S. Application Data
(63) Continuation-in-part of application No. 12/717,479, filed on Mar. 4, 2010.

(51) Int. Cl. H04B 7/00

(52) U.S. Cl. 455/41.3

(57) ABSTRACT

An input device includes an input module operated by a user to generate an input signal, a micro control unit, a memory unit having a plurality of preset protocol data fields, a Bluetooth driving unit, and a Bluetooth module. Each set of Bluetooth communication protocol codes stored in one protocol data field. The micro control unit is triggered by the input signal to output an output signal or an object switch signal. The Bluetooth driving unit is triggered by the object switch signal to access the Bluetooth communication protocol code from one protocol data field and send it to the Bluetooth module. The Bluetooth module receives the output signal and sends it to the linked information processing system, or receives the Bluetooth communication protocol code sent by the Bluetooth driving unit to establish a linkage with the information processing system corresponding to the Bluetooth communication protocol code.

This application is a continuation-in-part, and claims priority, of from U.S. patent application Ser. No. 12/717,479 filed on Mar. 4, 2010, entitled “MULTI-OBJECT SWITCH TRANSMISSION METHOD”, the entire contents of which are hereby incorporated by reference.

### FIELD OF THE INVENTION

The present invention relates to an input device with multi-object switch linkages and particularly to an input device to transmit input messages to multiple information processing systems through a Bluetooth transmission protocol.

### BACKGROUND OF THE INVENTION

Keyboard has become one of the necessary and basic output devices since computers have been developed in early stages. Although personal computers have gone through a great deal of progress these years, the keyboard still maintains substantially the same basic style. With improvements in material and structure, the size and weight of the keyboard have been reduced significantly in recent years. Composite keyboards that can be folded and expanded have been developed, and flexible keyboards that can be rolled and bent also are available. Many types of keyboards are being designed as portable computer accessories to facilitate carrying. However, there is still one constraint existed today that greatly limits the usability of the keyboard, i.e. linkage between the conventional keyboard and a computer system has to rely on a signal cable. The signal cable usually has a limited length that restricts distance and environment during use. To overcome this constraint, a wireless technology adopted on the keyboard has been proposed in prior art. For instance, R.O.C. patent No. 510537 entitled “Wireless keyboard” discloses a technique to transmit signals to a computer host through infrared ray or radio frequency (RF). While the keyboard adopted such a wireless technique (mainly the infrared ray) to transmit signals has mostly overcome the problem of the limited length of the signal cable, the infrared ray also has its disadvantages of limited linkage distance and angle, and easily blocked by obstacles. Hence signal transmission is easily interrupted and results in errors.

In addition to the need of constant improvement in signal transmission, the application scope of the conventional keyboard also is too narrow. In the past, the conventional keyboard merely is applied to computer systems. Before USB interface being widely used, the connection interface (such as PS2 connection terminal) of the keyboard can only be linked to a computer system. But users often have to input data to information products other than computers. For instance, R.O.C. patent No. 532523 entitled “A keyboard wirelessly connected with a PDA via infrared” adopts a technique in which a back rack is provided on a keyboard to function as a PDA holder. The back rack also has an infrared emitter. When a PDA is held on the back rack, transmission between the infrared emitter and the PDA can be maintained in a steady quality. Thus messages can be input from the keyboard to the PDA, and input speed is much faster than directly entering data on the PDA.

In recent years, Bluetooth technology has been introduced to the keyboard. For instance, R.O.C. patent No. M341266 entitled “Keys and keyboard” discloses a technique that uses a conductive sheet to form a portion of an antenna. The conductive sheet is bonded to or clamped under a key cap of a key so that the key includes part of the antenna. It not only provides Bluetooth transmission function, but also saves space.

Although the keyboard equipped with Bluetooth function provides greater usability than infrared transmission, the Bluetooth-enabled keyboard is mainly limited to wireless transmission between the keyboard and a single device at present. The technique of link selection and switch among multiple devices within the Bluetooth transmission range is not yet well adopted. There is still room for improvement on usability in terms of application scope of information products.

### SUMMARY OF THE INVENTION

In view of the aforesaid conventional techniques that still leave a lot to be desired, the present invention aims to provide an input device linked to multiple information processing systems to switch linking objects according to user's desire.

The present invention provides an input device with multi-object switch linkages. The input device includes an input module operated by a user to generate an input signal, a micro control unit electrically connected to the input module, a memory unit containing a plurality of preset protocol data fields, a Bluetooth driving unit electrically connected to the micro control unit and memory unit, and a Bluetooth module. Each information processing system has one set of Bluetooth communication protocol codes stored in one protocol data field. The micro control unit is triggered by the input signal to output an output signal or an object switch signal. The Bluetooth driving unit is triggered by the object switch signal to access the Bluetooth communication protocol code from one protocol data field and send the Bluetooth communication protocol code to the Bluetooth module. The Bluetooth module receives the output signal and sends the output signal to the linked information processing system, or receives the Bluetooth communication protocol code sent by the Bluetooth driving module to establish a linkage with the information processing system corresponding to the Bluetooth communication protocol code.

By means of the technique set forth above, the input device can store the Bluetooth communication protocol codes required for establishing data transmission linkages with multiple information processing systems. The Bluetooth communication protocol code can be a device identification code (Bd_address), a device authorization code (pin_code) or a combination of the device identification code (Bd_address) and device authorization code (pin_code). The user can drive the Bluetooth driving unit selectively through a key or a switch to access any one set of the Bluetooth communication protocol codes to establish a linkage with a corresponding information processing system.

In short, a user can use the input device of the invention to input information for different information processing systems in varying conditions to facilitate switching and also maintain the advantage of wireless transmission without cable constraint.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the invention.

FIG. 2 is a circuit block diagram of the input device of the invention.

FIG. 3 is a schematic view showing data access according to the invention.

FIG. 4 is a schematic view of a first embodiment of the invention.

FIG. 5 is a schematic view of a second embodiment of the invention.

FIG. 6 is a schematic view of a third embodiment of the invention.

FIG. 7 is a schematic view of a fourth embodiment of the invention.

FIG. 8 is a schematic view of a fifth embodiment of the invention.

### DETAILED DESCRIPTION OF THE PREFERRED EMBODIMENTS

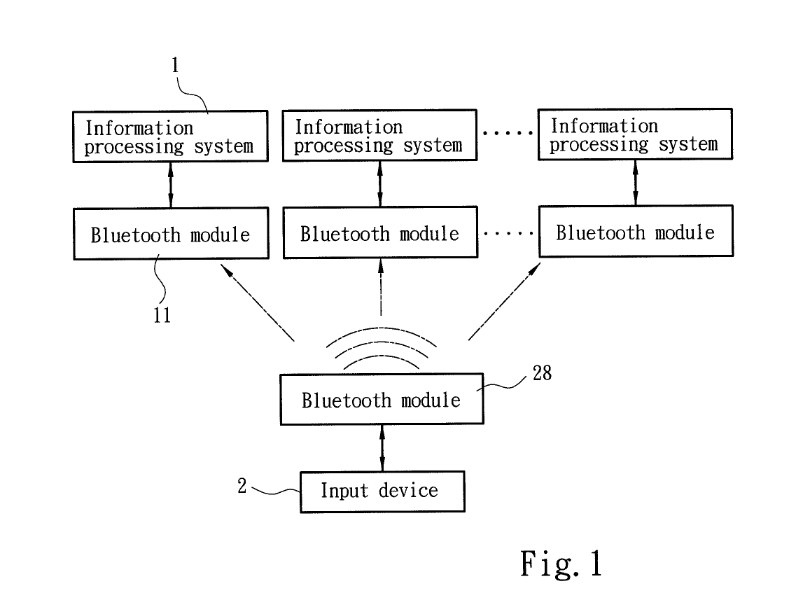

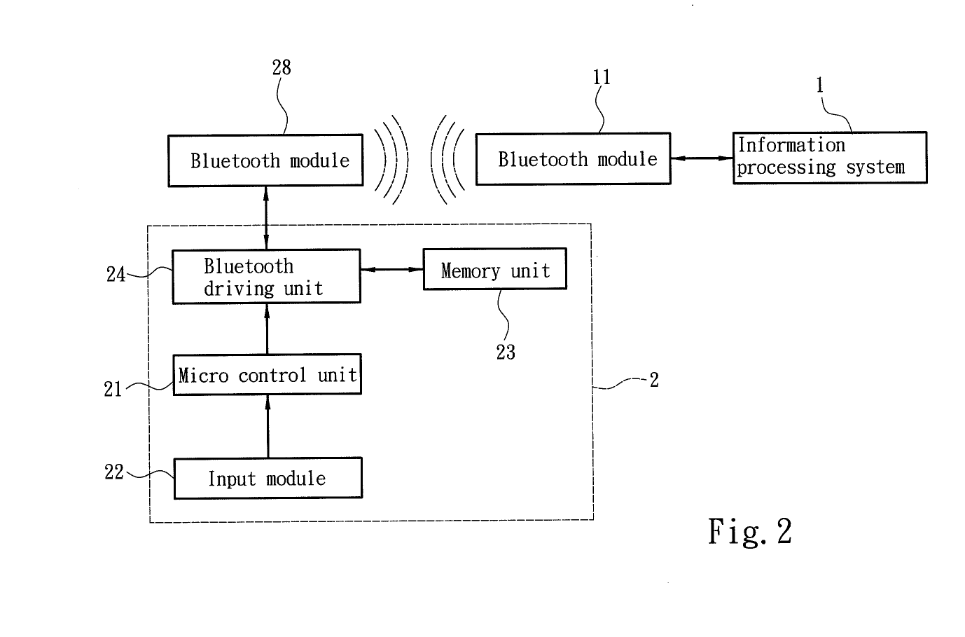

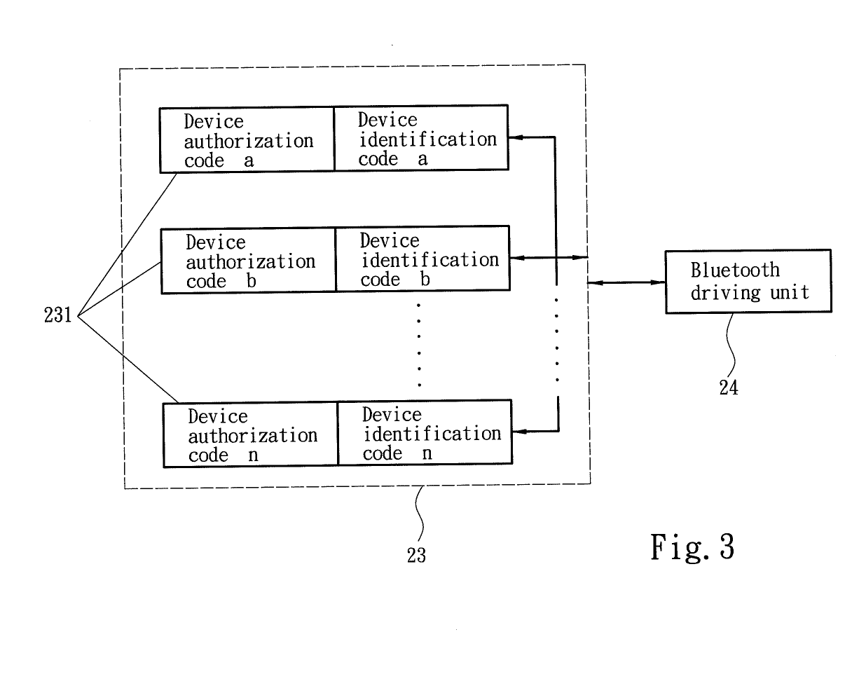

The present invention aims to provide an input device with multi-object switch linkages to establish a data transmission linkage between an input device 2 and at least one information processing system 1 through wireless transmission. Referring to FIGS. 1 and 2, the input device 2 contains a Bluetooth module 28 to establish a data transmission linkage with the information processing system 1 containing a Bluetooth module 11. The Bluetooth module 11 can be externally connected to or built in the information processing system 1. The Bluetooth module 28 can be externally connected to or built in the input device 2. The input device 2 includes a micro control unit 21, an input module 22, a memory unit 23 and a Bluetooth driving unit 24 electrically connected to the micro control unit 21 and memory unit 23. The memory unit 23 contains a plurality of preset protocol data fields 231 (also referring to FIG. 3). The input device 2 searches one set of Bluetooth communication protocol codes which is stored in one protocol data field 231 and linkable with the information processing system 1. When there are a plurality of linkable information processing systems 1 around the input device 2, the memory unit 23 saves multiple Bluetooth communication protocol codes in the protocol data fields 231. The Bluetooth communication protocol code can be a device identification code (Bd_address), a device authorization code (link key) or a combination of the device identification code (Bd_address) and device authorization code (link key). The input module 22 is operated by a user to generate an input signal sent to the micro control unit 21. According to different input signals, the micro control unit 21 is triggered by the input signal to output an output signal or an object switch signal. When the micro control unit 21 outputs the output signal, it is received by the Bluetooth driving unit 24 and then sent to the Bluetooth module 28 through the Bluetooth driving unit 24. The Bluetooth module 28 then receives the output signal and sends the output signal to the linked information processing system 1. When the micro control unit 21 outputs the object switch signal, the object switch signal triggers the Bluetooth driving unit 24 to access the Bluetooth communication protocol code from one protocol data field 231 of the memory unit 23 and sends the accessed Bluetooth communication protocol code to the Bluetooth module 28. The Bluetooth module 28 establishes a linkage with a corresponding information processing system 1 according to the accessed Bluetooth communication protocol code. Thereby the user can use the input module 22 to allow the micro control unit 21 to generate different object switch signals, so that the Bluetooth module 28 can be linked with different information processing systems 1 to achieve the function of quickly changing the linking object. The input module 22 further can trigger the micro control unit 21 to execute a search command to drive the Bluetooth driving unit 24 to search more linkable information processing systems 1 through the Bluetooth module 28 and access the Bluetooth communication protocol codes which are stored in the memory unit 23 and linkable with the information processing systems 1. Also refer to FIG. 3 for an embodiment in which the Bluetooth communication protocol code is a combination of the device identification code (Bd_address) and device authorization code (link key) to serve as an example. In FIG. 3, the memory unit 23 contains multiple preset protocol data fields 231 each stores one set of the Bluetooth communication protocol codes which is a combination of the device identification code (Bd_address) and the device authorization code (link key).

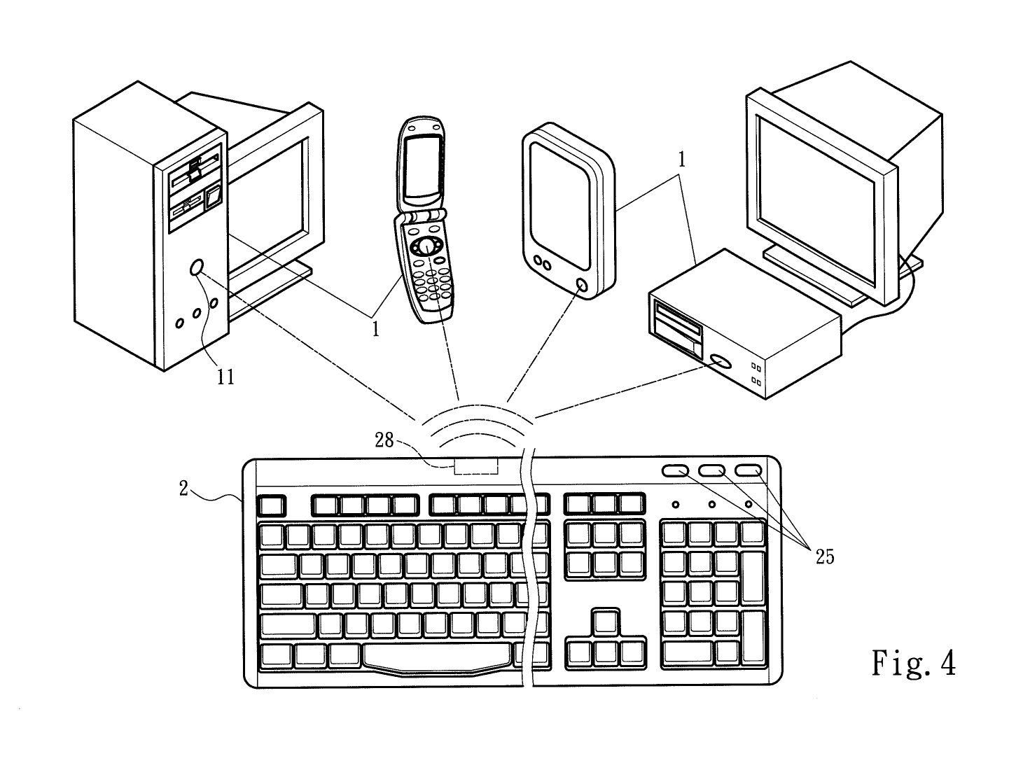

The aforesaid circuit structure can be implemented in a wide variety of embodiments. FIG. 4 illustrates a first embodiment in which the input device 2 is a keyboard including a plurality of keys and a plurality of device switch keys 25 to trigger the micro control unit 21 to output an output signal to the information processing system 1. Different device switch keys 25 can trigger the micro control unit 21 to generate different object switch signals corresponding to different protocol data fields 231. The Bluetooth driving unit 24 receives the object switch signal and accesses the corresponding protocol data field 231, and allows the Bluetooth module 28 to establish a linkage with a corresponding information processing system 1 according to the accessed Bluetooth communication protocol code in the protocol data field 231.

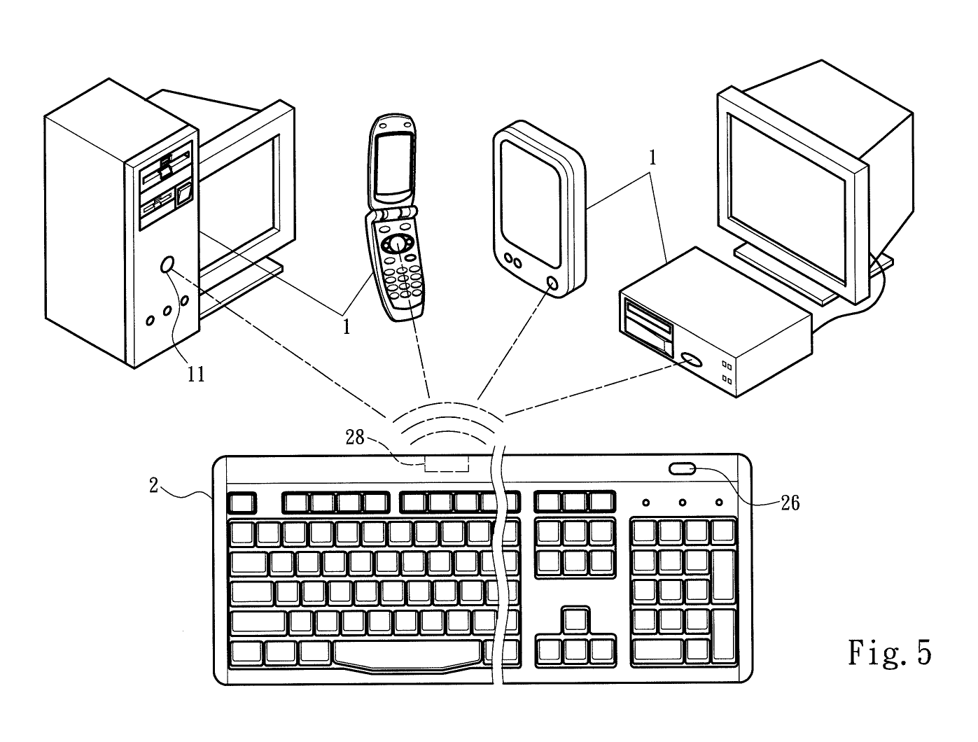

FIG. 5 shows a second embodiment in which the keyboard contains a plurality of keys to form multiple key combinations depressed to trigger the micro control unit 21 to generate different object switch signals corresponding to varying protocol data fields 231. Each key combination includes at least two keys. In the embodiment shown in FIG. 5, a switch function key 26 is provided. The switch function key 26 and at least one key are pressed to form a specific key combination to generate a corresponding selection signal. For example, the user presses the switch function key 26 first and then presses one of keys “F1” to “F4” to select one of four information processing systems 1 to establish a data transmission linkage.

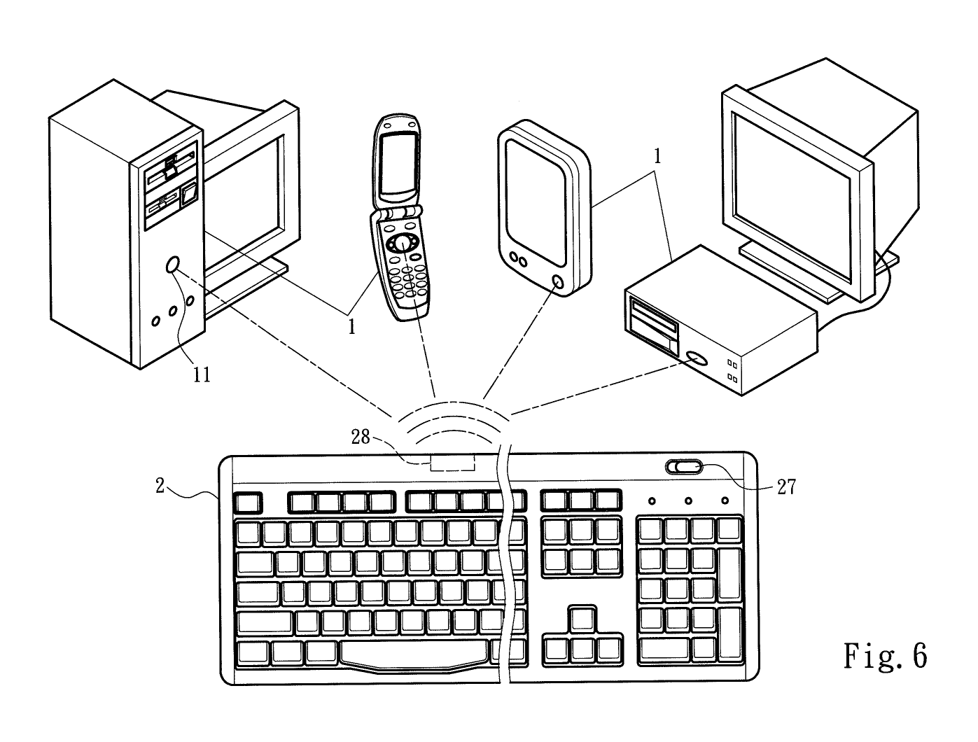

FIG. 6 depicts a third embodiment in which the keyboard includes a multi-stage switch 27 which has multiple switch selection positions to trigger the micro control unit 21 to generate different selection signals. As shown in the drawing, the information processing system 1 can be a computer, a mobile phone, a PDA (Personal Digital Assistant), or a TV game machine. The computer can also be a portable notebook computer.

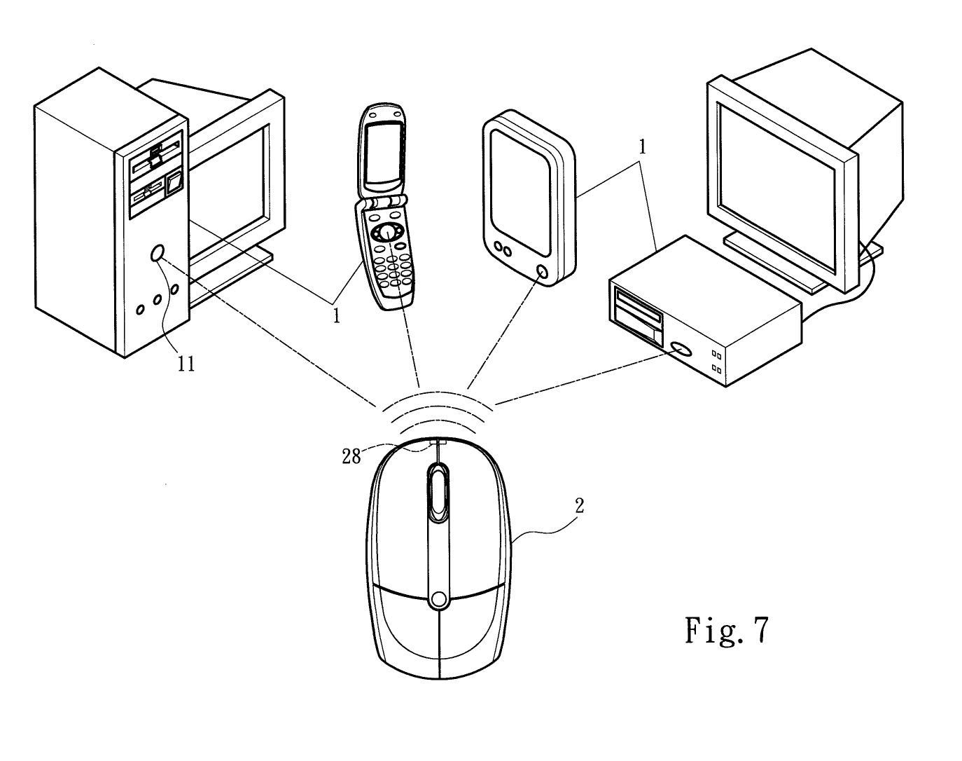

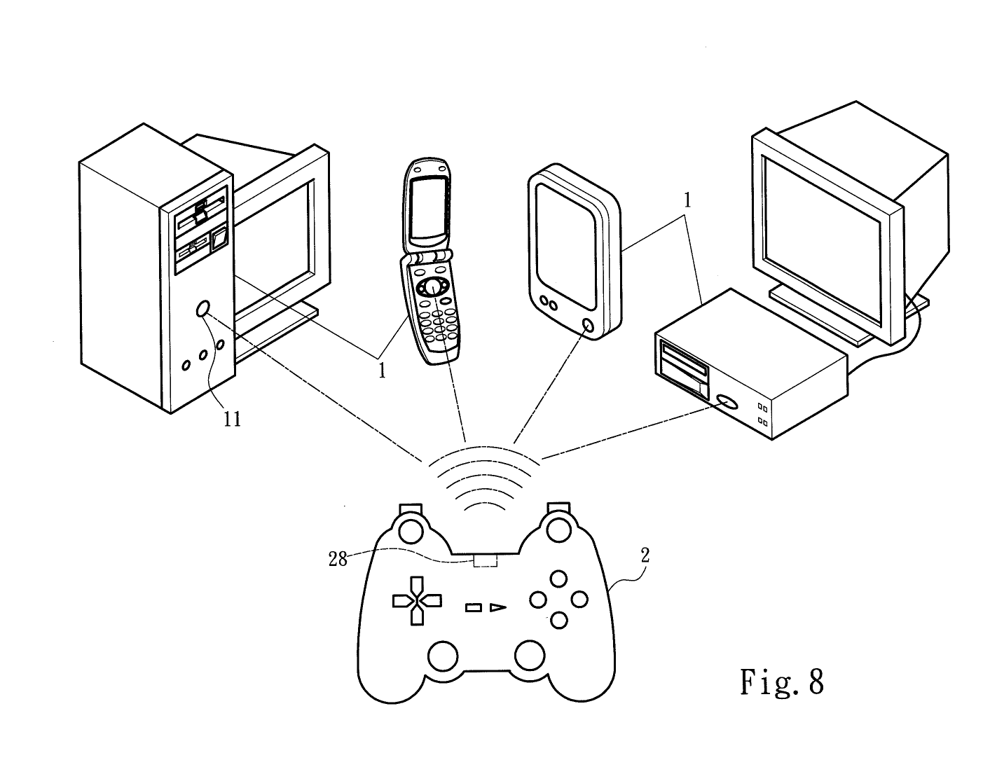

FIG. 7 shows a fourth embodiment in which the input device 2 is a mouse. FIG. 8 illustrates a fifth embodiment in which the input device 2 is a game controller. The mouse or game controller can selectively include the aforesaid device switch key, multiple key combinations or multi-stage switch as a switching control mechanism. The technique provided by the invention can be easily adopted by those skilled in the art, thus other alternative embodiments based on the invention shall be included in the scope of the invention. Through the selection mechanisms previously discussed, the micro control unit 21 can be triggered by the mouse or game controller to generate varying selection signals to drive the Bluetooth driving unit 24 to access the Bluetooth communication protocol code from a selected protocol data field 231 in the memory unit 23 to establish a linkage with a corresponding information processing system 1. Therefore, a handy switch function is provided and the advantage of wireless transmission without cable constraint can be also maintained.

While the invention has been described by means of specific embodiments, they are not the limitations of the invention. The corresponding access relationship between the Bluetooth communication protocol code and selection signal can be carried out in different fashions through various software or programming languages, such as address jump or the like. Since the way of data storage and access are not the focused features of the invention and the corresponding access methods are known to those skilled in computer programming techniques, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. An input device with multi-object switch linkages, comprising:
an input module operated by a user to generate an input signal;
a micro control unit electrically connected to the input module and triggered by the input signal to output an output signal or an object switch signal;
a memory unit including a plurality of preset protocol data fields each storing one set of Bluetooth communication protocol codes that is linkable with an information processing system;
a Bluetooth driving unit which is electrically connected to the micro control unit and the memory unit and triggered by the object switch signal to access the Bluetooth communication protocol code from one protocol data field of the memory unit to be output; and
a Bluetooth module receiving the output signal and sending the output signal to the linked information processing system or receiving the Bluetooth communication protocol code sent by the Bluetooth driving module to establish a linkage with one information processing system corresponding to the Bluetooth communication protocol code.

2. The input device of claim 1, wherein the output signal output by the micro control unit is received by the Bluetooth driving unit and sent to the Bluetooth module.

3. The input device of claim 1, wherein the Bluetooth communication protocol code is selectively a device identification code (Bd_address), a device authorization code (link key) or a combination of the device identification code (Bd_address) and the device authorization code (link key).

4. The input device of claim 1, wherein the input module further triggers the micro control unit to execute a search command to drive the Bluetooth driving unit to search more linkable information processing systems through the Bluetooth module and access the Bluetooth communication protocol codes which are stored in the memory unit and linkable with the information processing systems.

5. The input device of claim 1, wherein the input module includes a plurality of keys to generate the output signal, the keys including a plurality of key combinations depressed to trigger the micro control unit to output varying object switch signals to drive the Bluetooth driving unit to access varying protocol data fields, each key combination including at least two keys.

6. The input device of claim 1, wherein the input module includes a plurality of keys to generate the output signal and a multi-stage switch which includes multiple switch selection positions to trigger the micro control unit to output varying object switch signals to drive the Bluetooth driving unit to access varying protocol data fields.

7. The input device of claim 1, wherein the input module includes a plurality of keys to output the output signal and a plurality of device switch keys which are depressed to trigger the micro control unit to generate varying object switch signals to drive the Bluetooth driving unit to access varying protocol data fields.

8. The input device of claim 1, wherein the information processing system is selectively a computer, a mobile phone, a personal digital assistant (PDA) or a TV game machine.
